(19) United States
(12) Patent Application Publication
(10) Pub. No.: US 2018/0062897 A1
(43) Pub. Date: Mar. 1, 2018

(54) FREQUENCY DEVIATION REDUCTION AND DELAY COMPENSATION SCHEMES IN POLAR TRANSMITTERS

(71) Applicant: QUALCOMM Incorporated, San Diego, CA (US)

(72) Inventors: Kiran Kiran, Pleasanton, CA (US); Manikandan Chandrasekar, Bangalore (IN); Swaroop Venkatesh, San Ramon, CA (US)

(21) Appl. No.: 15/249,736

(22) Filed: Aug. 29, 2016

(51) Int. Cl. H04L 27/26; H04L 12/26; H04L 7/033; H04B 17/336

(52) U.S. Cl. CPC H04L 27/2623; H04L 43/16; H04J 11/00; H04B 17/336; H04L 7/033

(57) ABSTRACT

Methods, systems, and devices for wireless communication at a polar transmitter are described including: clipping at least a portion of an orthogonal frequency division multiplexing (OFDM) signal that exceeds a first predetermined threshold in a first sample; transferring the clipped portion of the OFDM signal to at least a second sample; and transmitting, by the polar transmitter, the OFDM signal.

### BACKGROUND

The present disclosure, for example, relates to wireless communication systems, and more particularly to methods and systems related to a polar transmitter enabled to transmit an orthogonal frequency divisional multiplexing signal.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include access points (APs) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via a downlink (DL) and uplink (UL). The DL (or forward link) may refer to the communication link from the AP to the station, and the UL (or reverse link) may refer to the communication link from the station to the AP.

In some cases, a polar transmitter may be used to dynamically modulate a signal; however, processing an orthogonal frequency division multiplexing (OFDM) signal may result in frequency deviations which are too large for a specifically designed phase locked loop (PLL) control system to adequately process.

### SUMMARY

A two-point polar transmitter may process an orthogonal frequency division multiplexing (OFDM) signal by converting real and/or complex signal components into amplitude and phase components. In addition, the phase component may be converted to a frequency deviation. The frequency deviation may be subsequently subjected to clipping the portion of the OFDM signal which exceeds a predetermined threshold, and transferring the clipped portion to a different signal. In some cases, the signal may be upsampled before clipping and transferring takes place.

A method for wireless communication is described. The method may include converting, by a polar transmitter, an orthogonal frequency division multiplexing (OFDM) signal into an amplitude component and a digital component; clipping, by the polar transmitter, at least a portion of the OFDM signal that exceeds a first predetermined threshold in a first sample; transferring, by the polar transmitter, the clipped portion of the OFDM signal to at least a second sample; and transmitting, by the polar transmitter, the OFDM signal.

An apparatus for wireless communication is described. The apparatus may include a processor, a polar transmitter in electronic communication with the processor; memory in electronic communication with the processor, and instructions stored in the memory. The instructions may be operable to cause the processor: convert an orthogonal frequency division multiplexing (OFDM) signal into an amplitude component and a phase component; clip at least a portion of the OFDM signal that exceeds a first predetermined threshold in a first sample, transfer the clipped portion of the OFDM signal to at least a second sample and transmit the OFDM signal.

A non-transitory computer readable medium for wireless communication is described. The non-transitory computer-readable medium may include instructions to cause a processor to: convert an orthogonal frequency division multiplexing (OFDM) signal into an amplitude component and a phase component, clip at least a portion of the OFDM signal that exceeds a first predetermined threshold in a first sample, transfer the clipped portion of the OFDM signal to at least a second sample and transmit the OFDM signal.

Some examples of the method, apparatus, or non-transitory computer-readable medium described above may further include processes, features, means, or instructions for clipping at least a portion of the second sample of the OFDM signal that exceeds the first predetermined threshold in the second sample. Some examples of the method, apparatus, or non-transitory computer-readable medium described above may further include processes, features, means, or instructions for transferring the clipped portion of the second sample of the OFDM signal to a third sample.

In some examples of the method, apparatus, or non-transitory computer-readable medium described above, transmitting the OFDM signal further comprises: converting a phase component of the signal to a frequency. In some examples of the method, apparatus, or non-transitory computer-readable medium described above, the clipping further comprises: clipping at least a portion of the OFDM signal if a frequency deviation satisfies a second predetermined threshold.

Some examples of the method, apparatus, or non-transitory computer-readable medium described above may further include processes, features, means, or instructions for establishing the predetermined threshold using parameters of a phase locked loop control system, where the predetermined threshold may be established by determining a signal-to-noise (SNR) ratio and/or a bandwidth. In some examples of the method, apparatus, or non-transitory computer-readable medium described above, transferring the clipped portion of the OFDM signal may further comprise transferring the clipped portion to a sample that is subsequent to the first sample.

Some examples of the method, apparatus, or non-transitory computer-readable medium described above may further include processes, features, means, or instructions for upsampling the OFDM signal by dividing a phase portion of the OFDM signal into at least two frequency deviations.

In some examples of the method, apparatus, or non-transitory computer-readable medium described above, the at least two frequency deviations increase in size as a bandwidth of the OFDM signal increases. In some examples of the method, apparatus, or non-transitory computer-readable medium described above, the polar transmitter is a two-point polar transmitter.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communications system in accordance with aspects of the present disclosure;

FIG. 2 illustrates a block diagram of an example polar transmitter in accordance with aspects of the present disclosure;

FIG. 3 illustrates an example of a process flow of a wireless communication in accordance with aspects of the present disclosure;

FIG. 4 illustrates an example signal graph of a wireless communication system in accordance with aspects of the present disclosure;

FIG. 5 illustrates a block diagram of a wireless communication system in accordance with aspects of the present disclosure;

FIG. 6 illustrates a block diagram of a wireless communication system in accordance with aspects of the present disclosure;

FIG. 7 illustrates a block diagram of a wireless communication system in accordance with aspects of the present disclosure;

FIG. 8 illustrates a block diagram of an example apparatus in a wireless communication system in accordance with aspects of the present disclosure;

FIG. 9 illustrates a method related to a wireless communication system in accordance with aspects of the present disclosure;

FIG. 10 illustrates a method related to a wireless communication system in accordance with aspects of the present disclosure; and

FIG. 11 illustrates a method related to a wireless communication system in accordance with aspects of the present disclosure.

### DETAILED DESCRIPTION

In traditional radio transmission architecture, a signal having real and complex components (i.e., a signal in the I/Q domain), may experience multiple zero-crossings (e.g., frequency deviation jumps), which make it difficult for an analog control system, such as a phase locked loop (PLL) control system, to adequately process. A polar transmitter may differ from a traditional Cartesian transmitter in that the polar transmitter may not maintain individual real and complex components; rather the polar transmitter may maintain the amplitude and phase of the signal. The transmission of an OFDM signal by a transmitter, however, inherently results in multiple zero-crossings, or large phase jumps or frequency deviations, which may prove difficult for the analog portion of a radio to process. Thus, techniques are discussed to reduce the amount of frequency deviation experienced in processing an orthogonal frequency division multiplexing (OFDM) signal, while also minimally distorting the OFDM signal, such that the signal can be processed by the analog portion of a polar transmitter while keeping a low power profile.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

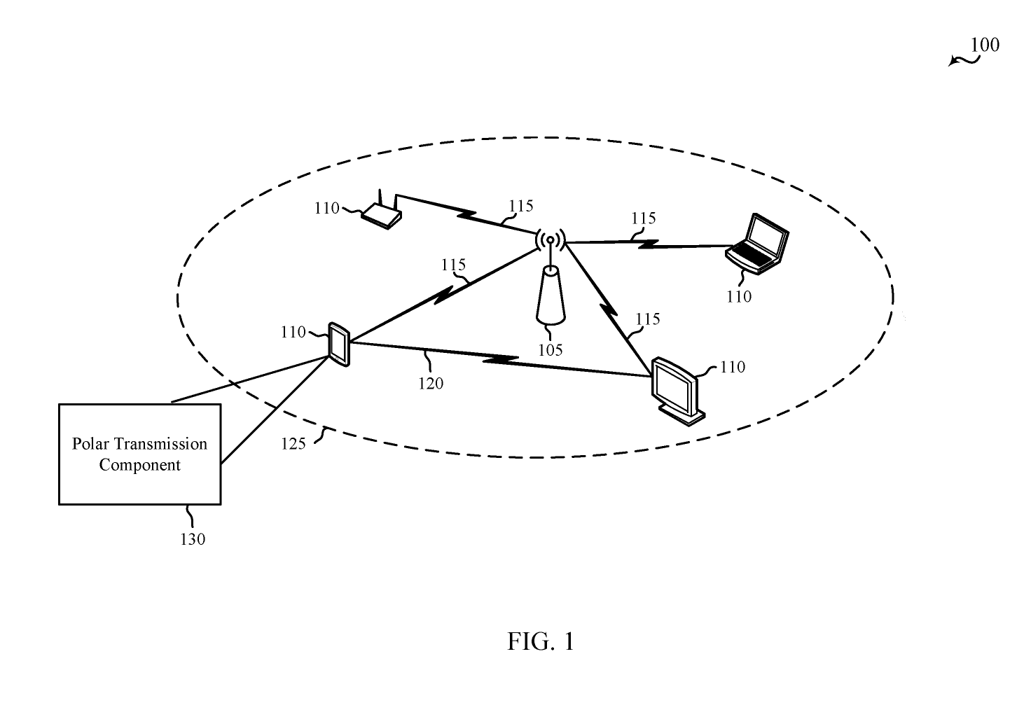

Referring first to FIG. 1, a block diagram illustrates an example of a wireless local area network (WLAN) network 100 such as, e.g., a network implementing at least one of the IEEE 802.11 family of standards, including the 802.11ah standards. The WLAN network 100 may include an access point (AP) 105 and one or more wireless devices or stations (STAs) 110, such as mobile stations, personal digital assistants (PDAs), other handheld devices, netbooks, notebook computers, tablet computers, laptops, display devices (e.g., TVs, computer monitors, etc.), printers, etc. While only one AP 105 is illustrated, the WLAN network 100 may have multiple APs 105. Each of the STAs 110, which may also be referred to as mobile stations (MSs), mobile devices, access terminals (ATs), user equipment (UE), subscriber stations (SSs), or subscriber units, may associate and communicate with an AP 105 via a communication link 115. Each AP 105 has a geographic coverage area 125 such that STAs 110 within that area can typically communicate with the AP 105. The STAs 110 may be dispersed throughout the geographic coverage area 125. Each STA 110 may be stationary or mobile. One or more of the STAs 110 may include a polar transmission component 130, which may enable the STAs 110 to reduce the frequency deviations associated with OFDM signal transmission.

In one embodiment, the AP 105 may comprise a radio transmitter. In some cases, the radio transmitter may employ a Cartesian architecture; however, in other cases, the radio transmitter may employ a polar transmission architecture. In some embodiments, as described herein, the polar transmitter may be established to enable the transmission of an orthogonal frequency divisional multiplexing (OFDM) signal.

Although not shown in FIG. 1, a STA 110 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) (not shown) is used to connect APs 105 in an extended service set. A geographic coverage area 125 for an AP 105 may be divided into sectors making up only a portion of the coverage area (not shown). The WLAN network 100 may include APs 105 of different types (e.g., metropolitan area, home network, etc.), with varying sizes of coverage areas and overlapping coverage areas for different technologies. Although not shown, other wireless devices can communicate with the AP 105.

While the STAs 110 may communicate with each other through the AP 105 using communication links 115, each STA 110 may also communicate directly with one or more other STAs 110 via a direct wireless link 120. Two or more wireless STAs 110 may communicate via a direct wireless link 120 when both STAs 110 are in the AP geographic coverage area 125 or when one or neither STA 110 is within the AP geographic coverage area 125 (not shown). Examples of direct wireless links 120 may include Wi-Fi Direct connections, connections established by using a Wi-Fi Tunneled Direct Link Setup (TDLS) link, and other P2P group connections. The STAs 110 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented within WLAN network 100.

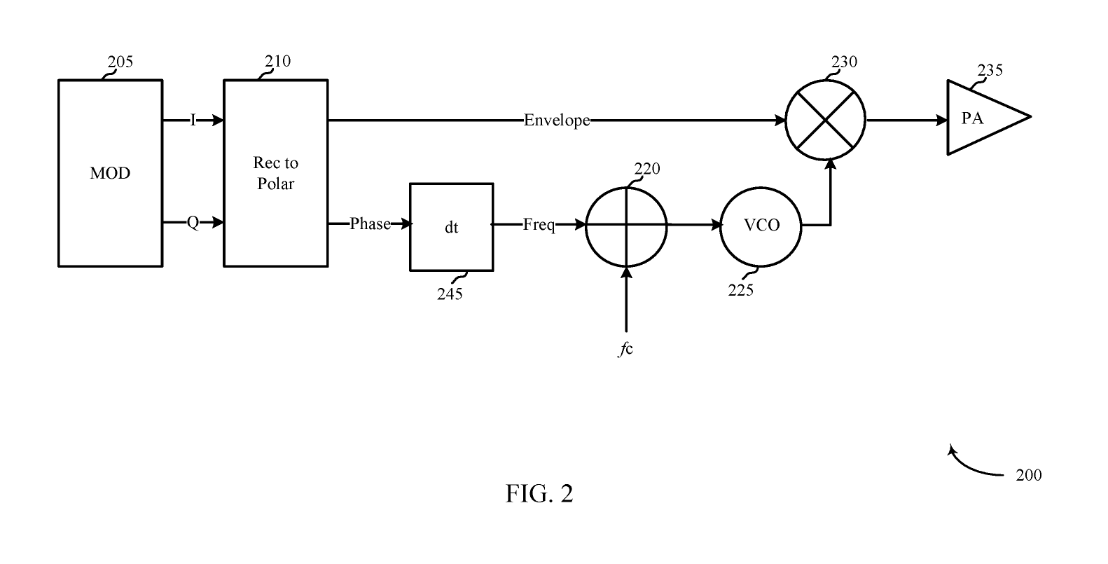

FIG. 2 illustrates a block diagram of an example polar transmitter 200 in accordance with aspects of the present disclosure. Polar transmitter 200 may include a modulator 205, a rectangular to polar converter 210, a differentiator 215, an adder 220, a voltage controlled oscillator (VCO) 225, a mixer 230, and a power amplifier 235.

The polar transmitter 200 may receive symbols as an input signal having a Cartesian representation (i.e., a complex signal with in-phase (I) and quadrature (Q) components), which may also be known as “rectangular form.” The input signal may be converted to a polar representation, which may also be known as “polar form,” using the rectangular to polar converter 210. The rectangular to polar converter 210 produces two signal components, an envelope (i.e., magnitude) component and a phase component. The phase component may be converted to frequency by a digital frequency converter shown as the time differentiator 215, and then offset (i.e., up-converted) to a carrier frequency fusing the adder 220. The upconverted frequency may be used to drive the voltage controlled oscillator 225 which generates a modulated sinusoidal signal. The envelope signal from the rectangular to polar converter 210 can be multiplied by the modulated sinusoid signal to provide an input for the power amplifier 235. The power amplifier 235 may amplify this signal for transmission through an antenna (not shown).

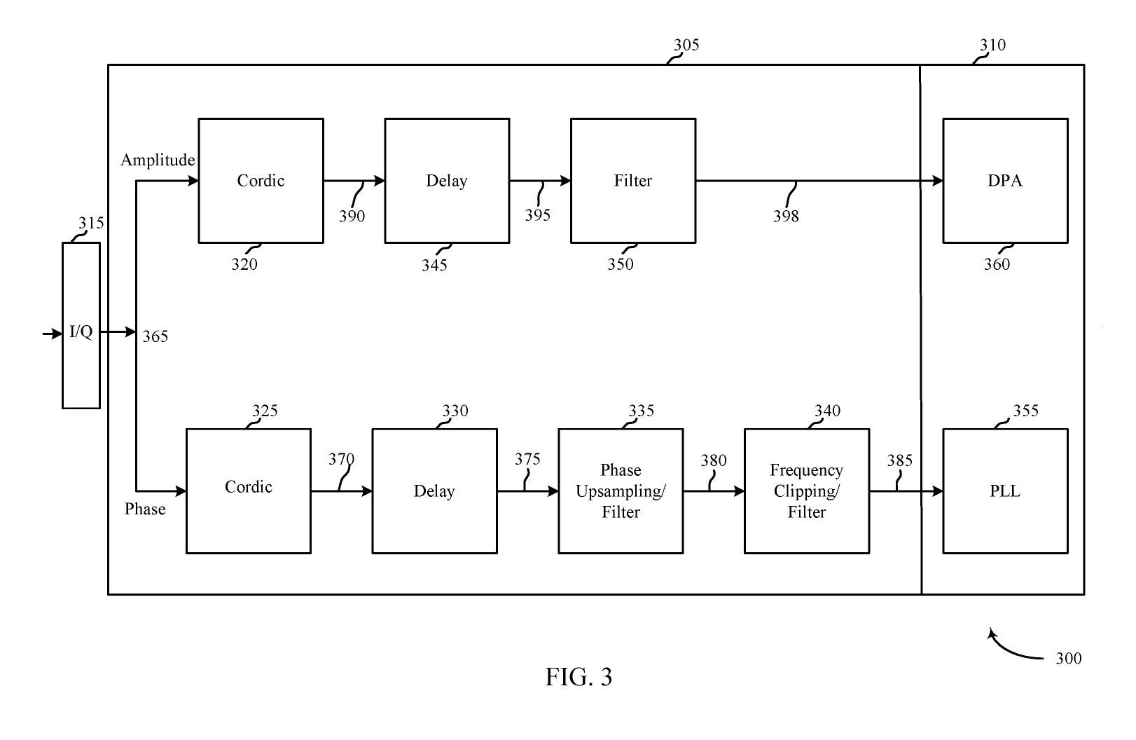

FIG. 3 illustrates an example of a process flow of a wireless communication in accordance with aspects of the present disclosure. In a traditional system, a radio transmitter may employ Cartesian architecture or an in-phase quadrature (I/Q) architecture. In this case, the OFDM signal may be retained in I/Q, or real and complex, components, and may vacillate from small to large values, as well as change signs, thus resulting in a potentially large number of zero-crossings (e.g., high frequency deviation). In one example, a zero-crossing is the point at which the sign of mathematical function representing frequency over time changes from positive to negative (and vice-versa).

Using a polar transmitter, as described with reference to FIG. 2, however, the OFDM signal may be converted into amplitude and phase components; the individual components along the real and imaginary axes are not maintained, and instead the individual components are replaced with amplitude and phase components.

FIG. 3 shows polar transmitter 300 divided into two portions: digital portion 305 and analog portion 310. Some processing steps in the digital portion 305 and in the analog portion 310 are shown; however, modulation and signal processing using the polar transmitter may include more steps than are shown in FIG. 3. In one example, polar transmitter 300 may be included on an STA 110 and/or an AP 105 illustrated in FIG. 1.

As a first step, OFDM signal 315 is received as input 365 into the polar transmitter 300, the OFDM signal 315 composed of I/Q components generated by a digital modem. The I/Q components of OFDM signal 315 may be received as input 365 into a coordinate rotation digital computer (cordic) 320 and/or 325, where the cordics apply an algorithm to extract the amplitude and phase components from the original I/Q components, respectively. Thus, a first cordic 320 extracts the amplitude component (represented by the upper path), while a second cordic 325 extracts the phase component (represented by the lower path). In one embodiment, the polar transmitter 300 may be a two-point polar transmitter, such that the phase component may be further broken down in a high frequency component and a low frequency component, where both components are subsequently fed into a phase locked loop (PLL) control system.

In one embodiment, the phase component (lower path) is then converted to frequency by applying a first order derivative, where the frequency will move from the digital portion 305 of the transmitter into the analog portion 310 of the transmitter by way of input into a phase locked loop (PLL) 355. The amplitude component (upper path) will move from the digital portion 305 of the transmitter into the analog portion 310 of the transmitter by way of input into a digital power amplifier (DPA) 350. In one embodiment, the amplitude component may be further input into a variable-gain amplifier, such as a digital variable-gain amplifier (DVGA), to affect power control. The amplitude component may further be processed to adjust for signal processing delay (at delay component 345) and/or additionally filtered (block 350), before the component is received as input 398 into the DPA.

As discussed previously, the OFDM signal may experience large frequency deviation which cannot be adequately processed by the PLL. Thus, the signal may be clipped (shown at block 340) if the signal exceeds a predetermined threshold, and the clipped portion of the signal transferred to another sample. The predetermined threshold may be determined by processing and/or power constraints imposed by the PLL; for example, constraints may be affected by consideration of throughput and bandwidth concerns. In addition, prior to clipping the signal, the signal may subject to upsampling and/or additional filtering (shown at block 335).

In addition, because the phase component of the signal and the amplitude portion of the signal are being processed separately, each component may experience some delay with respect to the other component. At the analog portion 310, however, the two components need to be realigned in time. Thus, a first delay component 345 and a second delay component 330 may enable realignment of the components before transmission of the OFDM signal.

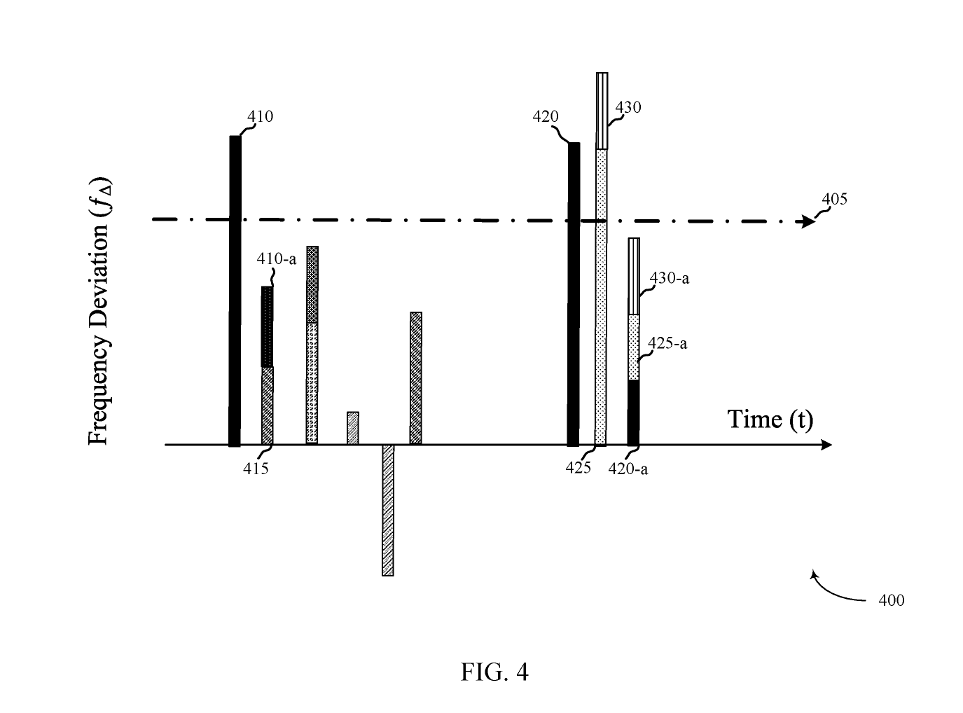

FIG. 4 illustrates an example signal graph 400 of a wireless communication system in accordance with aspects of the present disclosure. Bars representing the amount of frequency deviation of an OFDM signal are shown against a time axis. In one example, the wireless communication system may be operating under the 802.11ah standards imposed by the Institute of Electrical and Electronics Engineers (IEEE), although the system is not limited to these standards.

In one embodiment, a predetermined threshold 405 represents the amount of frequency deviation a specific PLL can process. If the frequency deviation for a signal exceeds the threshold, the PLL may not be able to adequately process the signal. In some cases, the signal may be ‘hard clipped,” where the signal is strictly limited and rejected at the threshold, resulting in a flat cutoff. However, hard clipping may result in a degradation of error vector magnitude (EVM) performance and subject to spectral mask issues at the final signal transmission stage.

Thus, in one embodiment the portion of the signal which exceeds the predetermined threshold is clipped at the threshold, and the clipped portion of the signal is transferred to another sample. As a result, the phase component of the signal is delayed; however, the clipping and transferring occurs at a predetermined rate such that the PLL processes the signal as if no clipping has occurred.

In one example, FIG. 4 may represent the processing of OFDM signal 315 as illustrated in FIG. 3, where each vertical bar represents a portion of the signal processed over time. Sample 410 (first solid black bar) is shown as exceeding the predetermined threshold 405. Thus, in this example, the polar transmitter “clips” the portion of sample 410 which occurs above the threshold and transfers the clipped portion of sample 410 (second solid black bar) to the subsequent sample. The subsequent sample is therefore made up of sample 415 and transferred sample 410-a, where transferred sample 410-a is the same sample as the portion of the sample 410 which exceeded threshold 405. Although FIG. 4 shows the clipped portion as transferred to a subsequent sample, the clipped portion may be transferred to a previous sample or a non-subsequent sample.

In another example, sample 420 (third solid black bar) exceeds predetermined threshold 405; however, in this example, the subsequent samples 425 and 430 also exceed predetermined threshold 405. Thus, when the polar transmitter clips the excessive portion of sample 420, the clipped portion cannot be transferred to the subsequent sample as the subsequent sample already exceeds the threshold. Thus, the portion of sample 420 which exceeds the threshold 405 is transferred to the non-subsequent third sample (shown as 420-a), and the portions of samples 425 and 430 which exceed predetermined threshold 405 are transferred to the subsequent sample as samples 425-a and 430-a.

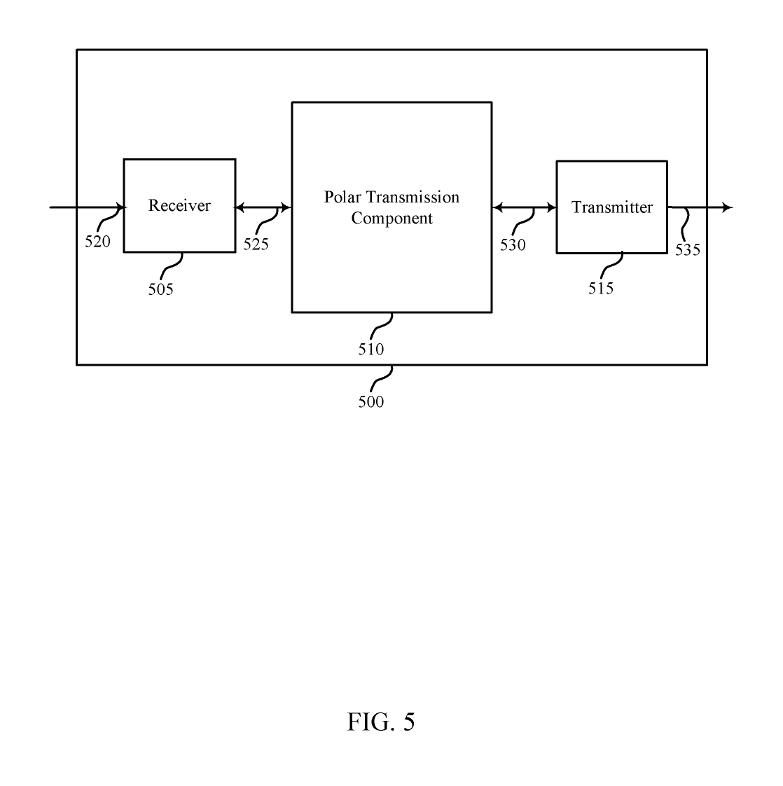

FIG. 5 illustrates a block diagram of a wireless communication system in accordance with aspects of the present disclosure. Wireless device 500 may be an example of aspects of a STA 110, an AP 105, or another transmission device described with reference to FIGS. 1 through 4. Wireless device 500 may include receiver 505, polar transmission component 510, and transmitter 515. Each of these components may be in communication with each other (e.g., via signals 520, 525, 530, and 535). Wireless device 500 may also include a processor. Each of these components may be in communication with each other.

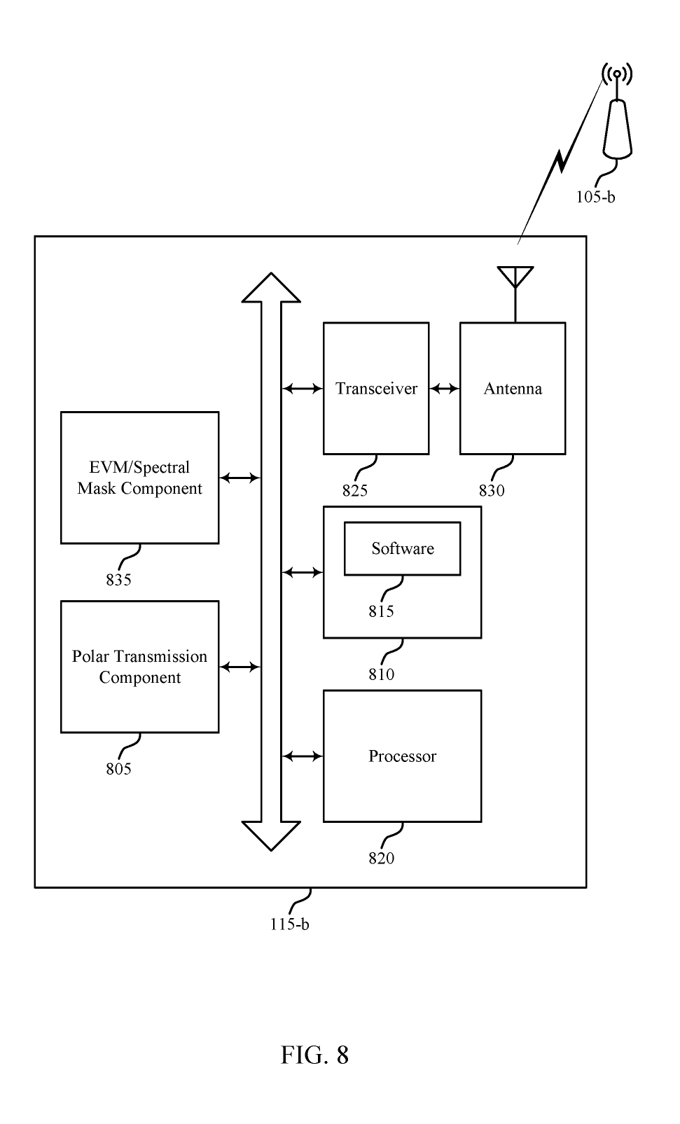

The receiver 505 may include a circuit or circuitry for receiving information such as packets, user data, or control information associated with various information channels (e.g., control channels, data channels, and information related to frequency deviation reduction and delay compensation in two-point polar transmitters, etc.). Information may be passed on to other components of the device. The receiver 505 may be an example of aspects of the transceiver 825 described with reference to FIG. 8.

The polar transmission component 510 may include a circuit or circuitry for clipping at least a portion of an OFDM signal that exceeds a first predetermined threshold in a first sample and transferring the clipped portion of the OFDM signal to at least a second sample. The polar transmission component 510 may also be an example of aspects of the polar transmission component 805 described with reference to FIG. 8. In one embodiment, the polar transmission component 510 may convert the FQ components of the OFDM signal to amplitude and phase components, and subsequently convert the phase component into a frequency. The polar transmission component 510 may also enable signal processing by way of DVGA power control processing, use of digital pre-distortion (DPD) AM-AM and/or AM-PM look up tables, additional amplitude operations, calibration, compensation, scaling, fixed-point operations, 3rd order sigma-delta modulation, and the like.

The transmitter 515 may include a circuit or circuitry for transmitting signals received from other components of wireless device 500. In some examples, the transmitter 515 may be collocated with a receiver in a transceiver component. For example, the transmitter 515 may be an example of aspects of the transceiver 825 described with reference to FIG. 8. The transmitter 515 may include a single antenna, or it may include a plurality of antennas.

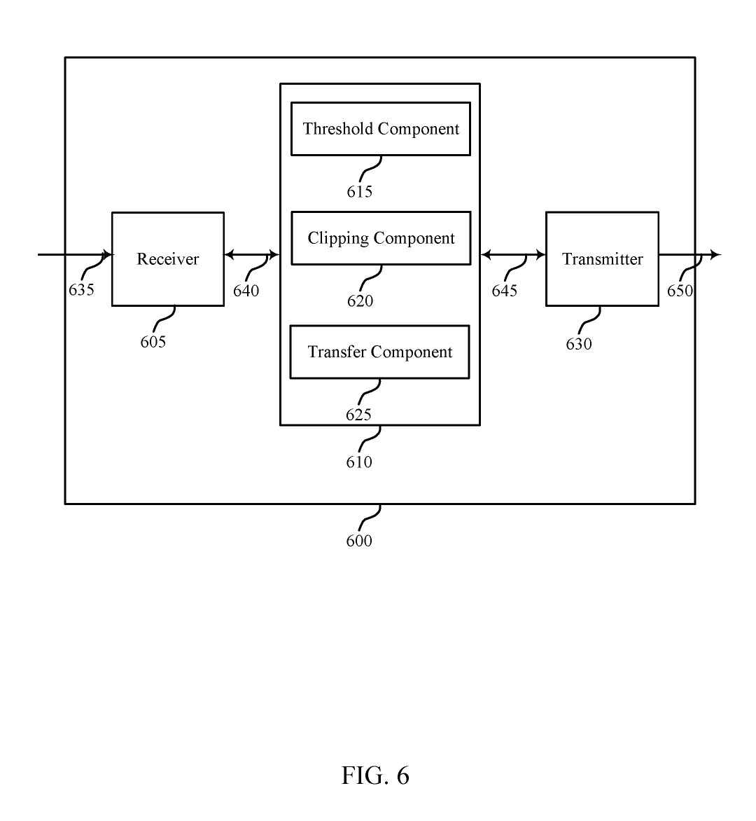

FIG. 6 illustrates a block diagram of a wireless communication system in accordance with aspects of the present disclosure. Wireless device 600 may be an example of aspects of a wireless device 500, a STA 110, an AP 105, or another polar transmission device described with reference to FIGS. 1 through 5. Wireless device 600 may include receiver 605, polar transmission component 610, and transmitter 630. In one example, transmitter 630 may be a polar transmitter, as described with reference to FIG. 2. In another example, transmitter 630 may be a two-point polar transmitter. Each of these components may be in communication with each other (e.g., via signals 635, 640, 645, and 650). Wireless device 600 may also include a processor. Each of these components may be in communication with each other.

The receiver 605 may include a circuit or circuitry for receiving information which may be passed on to other components of the device. The receiver 605 may also perform the functions described with reference to the receiver 505 of FIG. 5. The receiver 605 may be an example of aspects of the transceiver 825 described with reference to FIG. 8.

The polar transmission component 610 may be an example of aspects of polar transmission component 510 described with reference to FIG. 5. The polar transmission component 610 may include threshold component 615, clipping component 620 and transfer component 625. The polar transmission component 610 may be an example of aspects of the polar transmission component 805 described with reference to FIG. 8.

The threshold component 615 may include a circuit or circuitry for establishing a predetermined threshold indicative of the processing capabilities of the PLL control system. In one embodiment, a signal such as an OFDM signal may experience a large number of zero-crossings (i.e., frequency deviations) which may be difficult for an analog device such as the PLL to process. Thus, in processing the OFDM signal, the threshold component 515 may establish a predetermined threshold indicative of what the PLL is capable of processing while still meeting EVM and spectral mask requirements at the final transmission stage of the OFDM signal. In one embodiment, the threshold may be determined by way of considering throughput, bandwidth, signal-to-noise ratio (SNR), power consumption, and the like.

The clipping component 620 may include a circuit or circuitry for clipping at least a portion of an OFDM signal where the frequency deviation exceeds a predetermined threshold in a sample. For example, the PLL may be capable of processing a 4 MHz signal, but only if the frequency deviation of the signal does not exceed 130 MHz. Thus, if a signal experiences a frequency deviation that exceeds the predetermined threshold of 130 MHz, the excessive portion of the signal will be clipped and transferred to a different sample, thus enabling the PLL to adequately process the signal. In a second example, the PLL may be capable of processing a 1 MHz signal, but only if the frequency deviation of the signal does not exceed 40 MHz; thus, the portion of the signal which exceeds 40 MHz will be clipped and transferred to a different signal. The numerical examples given with respect to the clipping component 620 describe only some embodiments, and the system and methods are not limited to the numerical examples provided in this section.

The transfer component 625 may include a circuit or circuitry for transferring the clipped portion of the OFDM signal to a different sample from the original sample. In one embodiment, transferring the clipped portion of the OFDM signal includes transferring the clipped portion to a sample that is subsequent to the original sample, however in another embodiment, the clipped portion of the OFDM signal may be transferred to a previous sample or a non-subsequent sample. In some cases, a subsequent sample may also exceed a predetermined threshold, and thus the transfer component 625 may transfer the clipped portion of the OFDM signal to a sample which is not likely to exceed the predetermined threshold set by the threshold component 615.

The transmitter 630 may include a circuit or circuitry for transmitting signals received from other components of wireless device 600. In some examples, the transmitter 630 may be collocated with a receiver in a transceiver component. For example, the transmitter 630 may be an example of aspects of the transceiver 825 described with reference to FIG. 8. The transmitter 630 may utilize a single antenna, or it may utilize a plurality of antennas. In some examples, the transmitter 630 may be a polar transmitter. In other examples, the transmitter 630 may be a two-point polar transmitter.

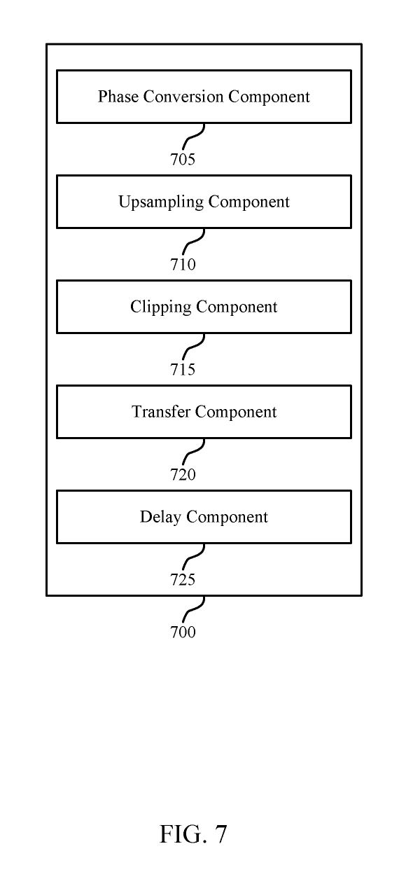

FIG. 7 illustrates a block diagram of a wireless communication system in accordance with aspects of the present disclosure. FIG. 7 shows a block diagram of a polar transmission component 700 which may be an example of the corresponding component of wireless device 500 or wireless device 600. That is, polar transmission component 700 may be an example of aspects of polar transmission component 510 or polar transmission component 610 described with reference to FIGS. 5 and 6. The polar transmission component 700 may also be an example of aspects of the polar transmission component 805 described with reference to FIG. 8. The polar transmission component 700 may include phase conversion component 705, upsampling component 710, clipping component 715, transfer component 720 and delay component 725. Each of these components may communicate, directly or indirectly, with one another (e.g., via one or more buses).

The phase conversion component 705 may include a circuit or circuitry for converting a phase component of the signal to a frequency. In one embodiment, the conversion of phase to frequency may involve taking a first-order derivative of the phase component. In another embodiment, the phase conversion component 705 may transform the phase into a frequency by way of a conversation of a discrete-time signal comprised of real and/or complex numbers into a complex frequency domain (e.g., a z-transformation). In one example, the equation used for the conversation may be: 1−z⁻¹; however, the conversion from phase to frequency need not be effected by way of a z-transformation, and other algorithms and methods may be considered.

The upsampling component 710 may include a circuit or circuitry for upsampling the OFDM signal by dividing the unwrapped phase portion of the OFDM signal into at least two frequency deviations. In some cases, the at least two frequency deviations increase in size as a bandwidth of the OFDM signal increases.

In some cases, a higher sampling rate may result in clipping and transferring portions of the OFDM signal close enough in time such that the PLL does not recognize the signal has been manipulated. Thus, the signal may be upsampled in the phase domain. In one embodiment, the phase component output from the cordic may be directly converted to a frequency deviation as described with respect to the phase conversion component 705. However, in another embodiment, prior to converting the phase to a rate-of-change of phase (i.e., to frequency), the phase portion of the sample may be sampled a number of times in order to reduce the amount of frequency deviation in the sample that is input into the PLL.

For example, the phase component may vacillate between a value of 0 and a value of it in two samples (e.g., the first sample may have a phase equal to 0 and the second sample may have a phase equal to π). In addition, the sampling rate may be set to 100 MHz. In this example, therefore, the frequency deviation is equal to 100n MHz, which may be too large of a frequency deviation for the PLL to process without suffering EVM and spectral mask degradation.

Thus, in another example embodiment, the phase component may be upsampled into smaller samples. For example, the first sample may equal 0, the second sample may equal 0.1 π, the third sample may equal 0.2 π, and so forth until the last sample is equal to π. Thus, the overall phase difference remains 0 to π, however, the size of the frequency deviation will be reduced by 1/10th. The numerical ranges and examples provided with respect upsampling component 710 describe some embodiments, and the methods and systems described herein are not constrained by these example ranges.

The clipping component 715 may be an example of the corresponding component of wireless device 600. That is, clipping component 715 may be an example of aspects of clipping component 620 described with reference to FIG. 6. The transfer component 720 may be an example of the corresponding component of wireless device 600. That is, transfer component 720 may be an example of aspects of transfer component 725 described with reference to FIG. 7.

The delay component 725 may include a circuit or circuitry for realigning delay of the amplitude and phase components before the components are input into the analog portion of the polar transmitter. In one embodiment, when the I/Q signal is input into the cordic resulting in an amplitude and a phase component, the two components of the signal are aligned in time, such that if the I/Q signal was reconstructed at this point in the process, the signal would be aligned. However, in another embodiment, the phase component may go through the extra processing steps described herein (e.g., upsampling clipping and transferring, filtering, etc.). Thus, the extra processing may cause a shift in alignment between the amplitude and the phase components. The delay component 725 may thus process the amplitude and phase components in order to realign each component before it the component is input into the analog portion of the polar transmitter (i.e., the DPA and PLL, respectively). In one embodiment, the delay component 725 may realign the signal by realigning an integer component of the signal in the I/Q domain, while realigning a fractional component of the signal in the amplitude/phase domain.

FIG. 8 illustrates a block diagram of an example apparatus in a wireless communication system in accordance with aspects of the present disclosure. For example, system 800 may include STA 110-b, which may be an example of a wireless device 500, a wireless device 600, or a STA 110 as described with reference to FIGS. 1 through 7. In other example, system 800 may represent a system including a wireless device such as an AP 105 or another polar transmission device as described herein.

STA 110-b may also include polar transmission component 805, memory 810, processor 820, transceiver 825, antenna 830 and EVM/Spectral mask component 835. Each of these components may communicate, directly or indirectly, with one another (e.g., via one or more buses). The polar transmission component 805 may be an example of a polar transmission component as described with reference to FIGS. 4 through 7.

The memory 810 may include random access memory (RAM) and read only memory (ROM). The memory 810 may store computer-readable, computer-executable software including instructions that, when executed, cause the processor to perform various functions described herein (e.g., frequency deviation reduction and delay compensation in two-point polar transmitters, etc.). In some cases, the software 815 may not be directly executable by the processor but may cause a computer (e.g., when compiled and executed) to perform functions described herein. The processor 820 may include an intelligent hardware device, (e.g., a central processing unit (CPU), a microcontroller, an application specific integrated circuit (ASIC), etc.)

The transceiver 825 may communicate bi-directionally, via one or more antennas, wired, or wireless links, with one or more networks, as described above. For example, the transceiver 825 may communicate bi-directionally with an AP 105-b or a STA 110-b. The transceiver 825 may also include a modem to modulate the packets and provide the modulated packets to the antennas for transmission, and to demodulate packets received from the antennas. In some cases, the wireless device may include a single antenna 830. However, in some cases the device may have more than one antenna 830, which may be capable of concurrently transmitting or receiving multiple wireless transmissions.

EVM/spectral mask component 835 may include a circuit or circuitry for ensuring the processing on the OFDM signal meets the EVM and spectral mask standards set by the IEEE. The IEEE may set a threshold that which the EVM and/or spectral mask must satisfy to ensure the transmitter is an IEEE compliant transmitter. For example, for the 802.11ah standard, the threshold may be −27 db, thus the threshold for the frequency deviation may be set at anything less than 20 MHz. A spectral mask threshold may also be set by the IEEE. Thus, in some embodiments, the EVM/spectral mask component 835 may impose limitations to ensure there is no accumulation of phase errors over the time the signal is being processed.

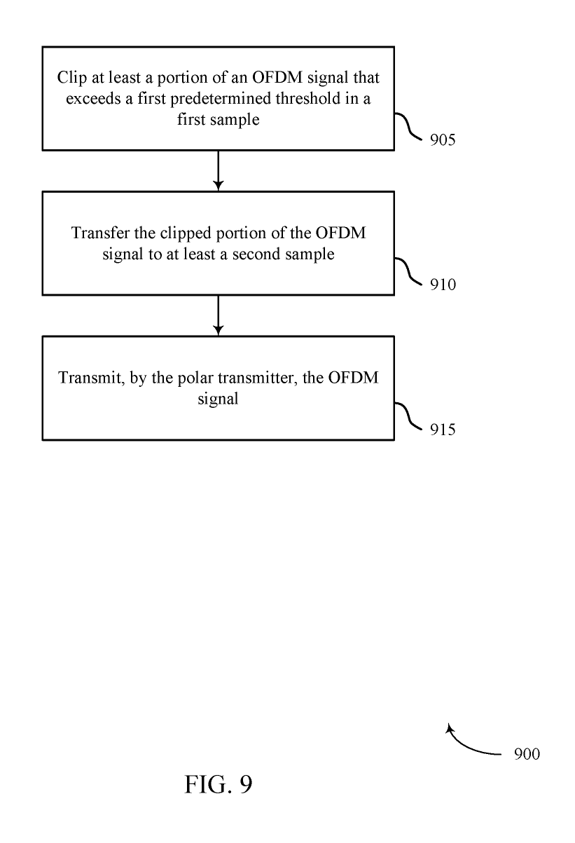

FIG. 9 illustrates a method related to a wireless communication system in accordance with aspects of the present disclosure. The operations of method 900 may be implemented by a device such as a polar transmitter or its components as described with reference to FIGS. 1 through 7. For example, the operations of method 900 may be performed by the polar transmission component 510 as described herein. In some examples, the polar transmission component may execute a set of codes to control the functional elements of the device to perform the functions described below. Additionally or alternatively, the polar transmission component may perform aspects the functions described below using special-purpose hardware.

At block 905, the polar transmitter may clip at least a portion of an OFDM signal that exceeds a first predetermined threshold in a first sample as described above with reference to FIGS. 2 through 8. In certain examples, the operations of block 905 may be performed by the signal clipping component as described with reference to FIG. 6.

At block 910, the polar transmitter may transfer the clipped portion of the OFDM signal to at least a second sample as described above with reference to FIGS. 2 through 7. In certain examples, the operations of block 910 may be performed by the transfer component as described with reference to FIG. 6.

At block 915, the polar transmitter may transmit the OFDM signal as described above with reference to FIGS. 2 through 7. In certain examples, the operations of block 915 may be performed by the transmitter as described with reference to FIG. 6.

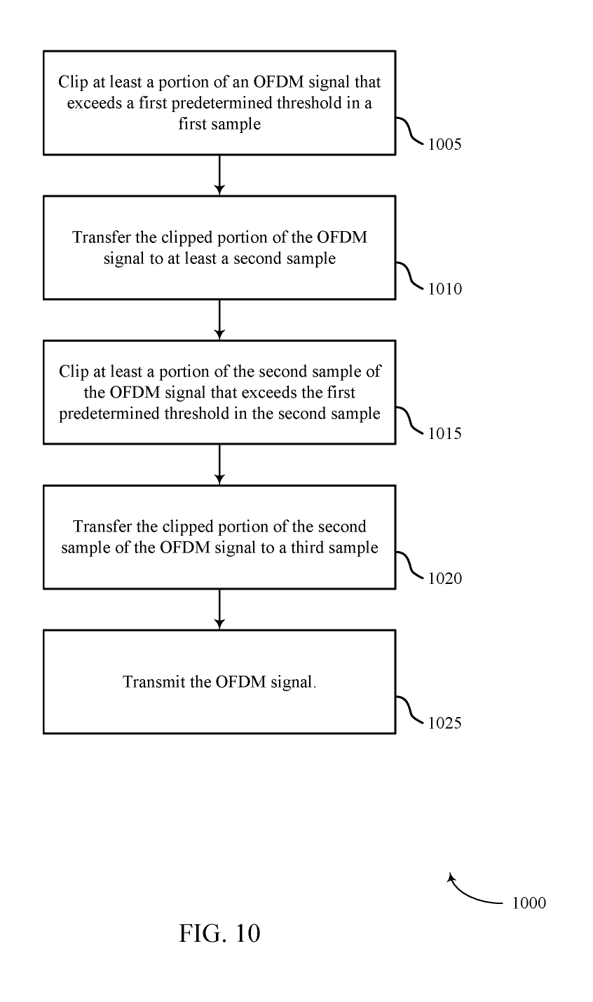

FIG. 10 illustrates a method related to a wireless communication system in accordance with aspects of the present disclosure. The operations of method 1000 may be implemented by a device such as a polar transmitter or its components as described with reference to FIGS. 1 through 8. For example, the operations of method 1000 may be performed by the polar transmission component 510 as described herein. In some examples, the polar transmitter may execute a set of codes to control the functional elements of the device to perform the functions described below. Additionally or alternatively, the polar transmitter may perform aspects the functions described below using special-purpose hardware.

At block 1005, the polar transmitter may clip at least a portion of an OFDM signal that exceeds a first predetermined threshold in a first sample as described above with reference to FIGS. 2 through 7. In certain examples, the operations of block 1005 may be performed by the clipping component as described with reference to FIG. 6.

At block 1010, the polar transmitter may transfer the clipped portion of the OFDM signal to at least a second sample as described above with reference to FIGS. 3 through 4. In certain examples, the operations of block 1010 may be performed by the transfer component as described with reference to FIG. 6.

At block 1015, the polar transmitter may clip at least a portion of the second sample of the OFDM signal that exceeds the first predetermined threshold in the second sample as described above with reference to FIGS. 3 through 4. In certain examples, the operations of block 1020 may be performed by the clipping component as described with reference to FIG. 6.

At block 1020, the polar transmitter may transfer the clipped portion of the second sample of the OFDM signal to a third sample as described above with reference to FIGS. 3 through 4. In certain examples, the operations of block 1025 may be performed by the transfer component as described with reference to FIG. 6.

At block 1025, the polar transmitter may transmit the OFDM signal as described above with reference to FIGS. 3 through 4. In certain examples, the operations of block 1015 may be performed by the transmitter described with reference to FIG. 6.

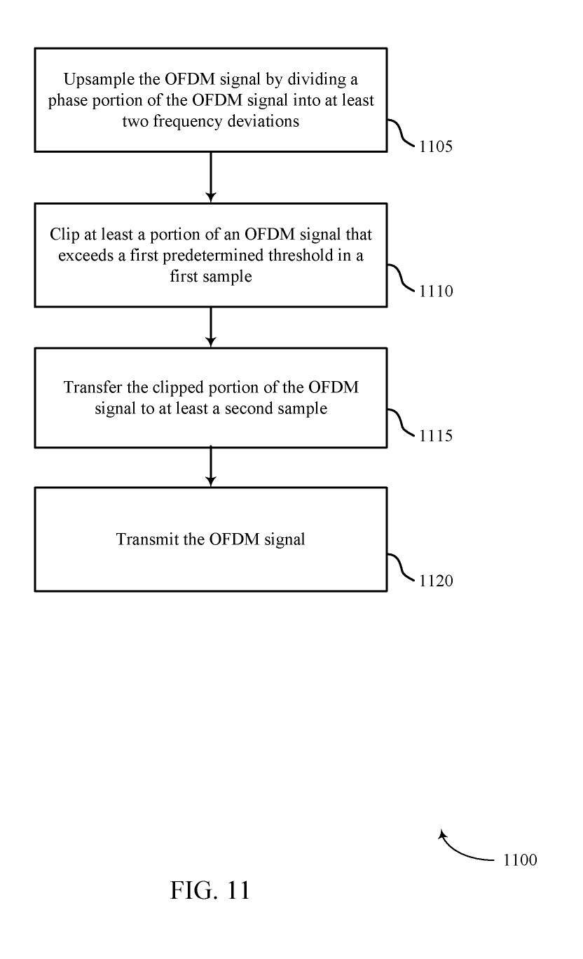

FIG. 11 illustrates a method related to a wireless communication system in accordance with aspects of the present disclosure. The operations of method 1100 may be implemented by a device such as a polar transmitter or its components as described with reference to FIGS. 1 through 8. For example, the operations of method 1100 may be performed by the polar transmission component as described herein. In some examples, the polar transmitter may execute a set of codes to control the functional elements of the device to perform the functions described below. Additionally or alternatively, the polar transmitter may perform aspects the functions described below using special-purpose hardware.

At block 1115, the polar transmitter may upsample the OFDM signal by dividing a phase portion of the OFDM signal into at least two frequency deviations as described above with reference to FIGS. 3 through 4. In certain examples, the operations of block 1115 may be performed by the upsampling component as described with reference to FIG. 6.

At block 1110, the polar transmitter may clip at least a portion of an OFDM signal that exceeds a first predetermined threshold in a first sample as described above with reference to FIGS. 3 through 4. In certain examples, the operations of block 1105 may be performed by the signal clipping component as described with reference to FIG. 6.

At block 1115, the polar transmitter may transfer the clipped portion of the OFDM signal to at least a second sample as described above with reference to FIGS. 3 through 4. In certain examples, the operations of block 1110 may be performed by the transfer component as described with reference to FIG. 6.

At block 1120, the polar transmitter may transmit the OFDM signal as described above with reference to FIGS. 3 through 4. In certain examples, the operations of block 1120 may be performed by the transmitter as described with reference to FIG. 6.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for frequency deviation reduction and delay compensation in two-point polar transmitters.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration). Thus, the functions described herein may be performed by one or more other processing units (or cores), on at least one IC. In various examples, different types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Thus, aspects of the disclosure may provide for frequency deviation reduction and delay compensation in two-point polar transmitters. It should be noted that these methods describe possible implementations, and that the operations and the steps may be rearranged or otherwise modified such that other implementations are possible. In some examples, aspects from two or more of the methods may be combined.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
converting, by a polar transmitter, an orthogonal frequency division multiplexing (OFDM) signal into an amplitude component and a digital component;
clipping, by the polar transmitter, at least a portion the OFDM signal that exceeds a first predetermined threshold in a first sample;
transferring, by the polar transmitter, the clipped portion of the OFDM signal to at least a second sample; and
transmitting, by the polar transmitter, at least the first and second samples of the OFDM signal.

2. The method of claim 1, further comprising:
clipping at least a portion of the second sample of the OFDM signal that exceeds the first predetermined threshold in the second sample;
transferring the clipped portion of the second sample of the OFDM signal to a third sample; and
transmitting at least the third sample of the OFDM signal.

3. The method of claim 1, wherein transmitting the OFDM signal further comprises:
converting a phase component of the signal to a frequency.

4. The method of claim 3, wherein the clipping further comprises:
clipping at least a portion of the OFDM signal if a frequency deviation satisfies a second predetermined threshold.

5. The method of claim 1, further comprising:
establishing the predetermined threshold using parameters of a phase locked loop control system.

6. The method of claim 5, wherein establishing the predetermined threshold further comprises:
determining a signal-to-noise ratio (SNR).

7. The method of claim 5, wherein establishing the predetermined threshold further comprises:
determining a bandwidth.

8. The method of claim 1, wherein transferring the clipped portion of the OFDM signal comprises:
transferring the clipped portion to a sample that is subsequent to the first sample.

9. The method of claim 1, further comprising:
upsampling the OFDM signal by dividing a phase portion of the OFDM signal into at least two frequency deviations.

10. The method of claim 9, wherein the at least two frequency deviations increase in size as a bandwidth of the OFDM signal increases.

11. The method of claim 1, wherein the polar transmitter is a two-point polar transmitter.

12. An apparatus for wireless communication, comprising:
a processor;
a polar transmitter in electronic communication with the processor;
memory in electronic communication with the processor; and
instructions stored in the memory and operable, when executed by the processor, to cause the processor to:
convert an orthogonal frequency division multiplexing (OFDM) signal into an amplitude component and a phase component;
clip at least a portion of the OFDM signal that exceeds a first predetermined threshold in a first sample;
transfer the clipped portion of the OFDM signal to at least a second sample; and
transmit at least the first and second samples of the OFDM signal.

13. The apparatus of claim 12, wherein the instructions are further operable to cause the processor to:
clip at least a portion of the second sample of the OFDM signal that exceeds the first predetermined threshold in the second sample;
transfer the clipped portion of the second sample of the OFDM signal to a third sample; and
transmit at least the third sample of the OFDM signal.

14. The apparatus of claim 12, wherein when the processor transmits the OFDM signal, the instructions are further operable to cause the processor to:
convert a phase component of the signal to a frequency.

15. The apparatus of claim 13, wherein when the processor clips at least a portion of the second sample, the instructions are further operable to cause the processor to:
clip at least a portion of the OFDM signal if a frequency deviation satisfies a second predetermined threshold.

16. The apparatus of claim 12, wherein the instructions are further operable to cause the processor to:
establish the predetermined threshold using parameters of a phase locked loop control system.

17. The apparatus of claim 12, wherein when the processor transfers the clipped portion of the OFDM signal, the instructions are further operable to cause the processor to:
transfer the clipped portion to a sample that is subsequent to the first sample.

18. The apparatus of claim 12, wherein the instructions are further operable to cause the processor to:
upsample the OFDM signal by dividing a phase portion of the OFDM signal into at least two frequency deviations.

19. The apparatus of claim 18, wherein the at least two frequency deviations increase in size as a bandwidth of the OFDM signal increases.

20. A non-transitory computer-readable medium storing code for wireless communication, the code comprising instructions executable to cause a polar transmitter to:
convert an orthogonal frequency division multiplexing (OFDM) signal into an amplitude component and a digital component;
clip at least a portion of the OFDM signal that exceeds a first predetermined threshold in a first sample;
transfer the clipped portion of the OFDM signal to at least a second sample; and
transmit at least the first and second samples of the OFDM signal.
